(19) United States
(12) Patent Application Publication
(10) Pub. No.: US 2015/0088778 A1
(43) Pub. Date: Mar. 26, 2015

(54) System and method for verifying a travelers authorization to enter into a jurisdiction using a software application installed on a personal electronic device

(71) Applicants: Adam Y. Tsao, Washington, DC (US); Hans C. Miller, Arlington, VA (US)

(72) Inventors: Adam Y. Tsao, Washington, DC (US); Hans C. Miller, Arlington, VA (US)

(21) Appl. No.: 14/495,349

(22) Filed: Sep. 24, 2014

Related U.S. Application Data
(60) Provisional application No. 61/881,621, filed on Sep. 24, 2013.

(51) Int. Cl. G06Q 50/26; H04L 9/32

(52) U.S. Cl. CPC G06Q 50/265; H04L 9/32; H04L 2209/24
USPC 705/325

(57) ABSTRACT

The present disclosure relates generally to a system and method, which allows travelers to process themselves using a software application installed on a personal electronic device to receive authorization to enter into a jurisdiction. Such system and method includes: a personal electronic device software application (App) for electronically storing therein official passport data for a traveler and members of the traveler's family group and pictures used to identify each passport holder, for posing a series of questions to the traveler, for receiving authorizations to enter into a jurisdiction, and for displaying a secure encrypted receipt on a personal electronic device; means for authenticating the secure receipt; means to transmit passport and travel information to customs authorities from a personal electronic device to determine whether the traveler and the members of the traveler's family group have received authorization to enter into a jurisdiction; and a kiosk for capturing travelers' biometrics and for transmitting passport, biometric and travel information to customs authorities to determine whether the traveler and the members of the traveler's family group have received authorization to enter into a jurisdiction.

### REFERENCE TO PRIOR APPLICATION

This application ties to the provisional patent application 61/881,621 filed Sep. 24, 2013 to inventors Adam Y. Tsao of Washington, D.C. and Hans C. Miller of Arlington, Va.

### GENERAL FIELD OF INVENTION

The invention relates to the processing of travelers, and more particularly, to the processing of travelers arriving into a jurisdiction from another jurisdiction.

### BACKGROUND

The travelers arriving to a jurisdiction from another jurisdiction must be processed through a government-operated customs facility to determine whether they can be granted entry. Typically, the traveler presents a completed paper declaration form for customs purposes and a passport to a customs official. The customs official inspects the form and passport, determines whether passage can be granted, and marks a code on the form for use by a second customs official controlling the exit point.

The entry process often results in long lines that delay travelers. One attempt to resolve this problem is with Government security programs that allow travelers to participate in a pre-screening process. An example of such a program is Global Entry, a program for self-service border clearance into the United States. Global Entry is available to United States citizens and requires enrollees to submit biometrics, undergo an interview and pay of a fee. There are over 1.9 million Global Entry members. Global Entry members use kiosks to process themselves and skip the typical entry process. The number of Global Entry users is too low to significantly reduce the lines associated with border crossings.

### SUMMARY OF INVENTION

The system and method according to the invention includes a personal electronic device software application (App) that electronically stores official passport data for a traveler and members of the traveler's family group and stores pictures used to identify each passport holder. For each trip to a jurisdiction, the traveler must answer a series of questions posed in the App. Upon arrival to the jurisdiction, the traveler submits the answers to the questions and the passport information for each traveler traveling in the family group to the customs authority via the App or via a kiosk and associated infrastructure.

The border crossing authority uses this information from App, and the kiosk under certain circumstances, to determine whether each traveler has been granted passage into the jurisdiction. If each traveler in the family group receives a passage granted referral code, the App will create a receipt for each traveler that contains the picture of the traveler, traveler information, an encrypted QR code and a scrolling time stamp that displace time remaining that the receipt is valid. If any traveler in the family group does not receive a passage granted referral code, all passengers in the party will be referred to a customs official. Upon receiving the receipt, travelers will present the receipt to a QR code reader to validate the receipt and proceed with entry into the United States at the discretion of a customs official.

The benefits of the system and method according to the invention include improved border protections, improved customer service, more effective and efficient use of government resources, and increased border crossing facility capacity.

An App for processing travelers is provided, including: means for receiving and reading information from passports, means for taking a photograph of each passport holder, means for providing questions to the traveler, communication means for transmitting the information from the passport and the answers to the questions to a government computer, communications means for receiving a code from the government computer, and means for presenting a secure electronic receipt on a personal electronic device.

A system for processing travelers into a jurisdiction is provided, including: (a) a App having: means for receiving and reading information from a passport associated with the traveler and means for providing questions to the traveler, communication means for transmitting the information from the passport and the answers to the questions to a government computer, communications means for receiving a code from the government computer, and means for presenting a secure electronic receipt on a personal electronic device; and (b) a QR code reader that can validate the secure electronic receipt displayed on the personal electronic device.

An App for processing travelers is provided, including: means for receiving and reading information from passports, means for taking a photograph of each passport holder, means for providing questions to the traveler, communication means for transmitting the information from the passport and the answers to the questions to a kiosk for receiving and reading traveler biometrics, communications means for receiving a code from a kiosk for receiving and reading traveler biometrics, and means for presenting a secure electronic receipt on a personal electronic device.

A kiosk for processing a traveler is provided, including: means for receiving and reading traveler biometrics, means for receiving information from an App that includes traveler passport information and the answers to the questions, communication means for transmitting the information from the App and biometric information to a government computer, communications means for receiving a code from the government computer, and means to transmit the code to the App.

A system for processing travelers into a jurisdiction is provided, including (a) an App having the means for receiving and reading information from passports, means for taking a photograph of each passport holder, means for providing questions to the traveler, communication means for transmitting the information from the passport and the answers to the questions to a kiosk for receiving and reading traveler biometrics, communications means for receiving a code from a kiosk for receiving and reading traveler biometrics, and means for presenting a secure electronic receipt on a personal electronic device; and (b) a kiosk having: means for receiving and reading traveler biometrics, means for receiving information from App that includes traveler passport information and the answers to the questions, communication means for transmitting the information from the App and biometric information to a government computer, communications means for receiving a code from the government computer, means to transmit the code to the App; and (c) a QR code reader that can validate the secure electronic receipt displayed on the personal electronic device.

A method for processing a traveler is provided, including the steps of: (a) providing an App to the traveler use for on a personal electronic device, (b) the App receiving and reading passport information for said traveler, (c) the App providing the means for taking a photograph of each passport holder, (d) the App providing a plurality of questions to the traveler, (e) the App transmitting information about the traveler to a government computer, (f) the App receiving a code from the government computer, (g) the App displaying a secure electronic receipt for the traveler on a personal electronic device, the receipt containing an encrypted QR code, and (h) providing a QR code reader that validates the receipt.

A method for processing a traveler is provided, including the steps of: (a) providing an App to the traveler for: use on a personal electronic device, for receiving and reading passport information for said traveler, for providing the means for taking a photograph of each passport holder, for providing a plurality of questions to the traveler, for transmitting information about the traveler to a kiosk for receiving and reading biometrics; (b) providing a kiosk for: receiving information from App that includes traveler passport information and the answers to the questions, for receiving and reading traveler biometrics, for transmitting the information from the App and biometric information to a government computer, for a code from the government computer, and for transmitting the code to the App; (d) the App for receiving a code from the kiosk for receiving and reading biometrics, for displaying a secure electronic receipt for the traveler on a personal electronic device, the receipt containing an encrypted QR code; and (m) providing a QR code reader that validates the receipt.

### BRIEF DESCRIPTION OF DRAWINGS

FIG. 1 is a block diagram showing the system according to the invention;

FIG. 2 is a block diagram of a kiosk according to the invention;

FIG. 3 is a flow chart showing the process by which travelers are processed according to the invention;

FIG. 4 is a flow chart showing an alternative embodiment of a process by which passengers are processed according to the invention;

FIG. 5 is block diagram showing the system for validating the receipt according to the invention;

FIGS. 6a to 6c are representations of App screens displayed on the traveler's personal electronic device according to the invention.

FIG. 7 is a representation of the receipt screen displayed on the traveler's personal electronic device according to the invention.

### DETAILED DESCRIPTION

In this document, the following terms will have the following meanings:

“traveler” means a person arriving into a jurisdiction from another jurisdiction. A traveler may be alone or may be traveling with a members of a family group of travelers.

“customs” means process for controlling entrance by persons and goods into a jurisdiction;

customs authority” means the government agency responsible for controlling entrance by persons and goods into the United States, and is often responsible for both customs and immigration;

“jurisdiction” means a legal territory with borders monitored by a custom authority.

A jurisdiction is typically, but not necessarily, a country;

“government computer” means a conventional computer, or a network of computers containing a database of travelers and passport holders, and information about potential travelers. The government computer may be operated by a customs authority;

“personal electronic device” means any device that a traveler is in possession of which electronically communicates, sends, receives, stores, reproduces or displays voice and/or text communication or data.

“App” means any software installed on a personal electronic device and executable on such device.

“kiosk” means a self-service computer that allows travelers entering a jurisdiction to enter information or biometrics. The kiosks may be networked using a server, or each may be independently in communication with a government computer.

“biometrics” means traveler's unique physical and other traits that can be detected and recorded by an electronic device or system as a means of confirming identity.

The system according to the invention provides for an efficient means of processing travelers entering a jurisdiction. Travelers may download the software application (App) to their personal electronic device. After such time a traveler may scan their passports (or enter passport information manually) and take a photo of each passport holder any time. Prior to arriving into a jurisdiction, travelers must answer questions about themselves and their travel. Upon arrival into the jurisdiction, travelers submit their passport information and answers to the customs authority via the App. Under certain circumstances, the traveler will submit their information to a kiosk via the App, scan their fingerprints and submit their fingerprints, passport information and answers to the government via the kiosk. After this process, if the government confirms that passage can be granted, the App will receive codes and will issue a secure encrypted receipt, which is then validated by a QR code reader. The customs officer may allow the traveler entry to the jurisdiction.

The system and method according to the invention will be described herein in relation to an airport and travelers who are arriving in the jurisdiction via an airplane, however, the system and method may be used with other forms of transport, including sea (eg by boat), or land (eg by train, auto or bus).

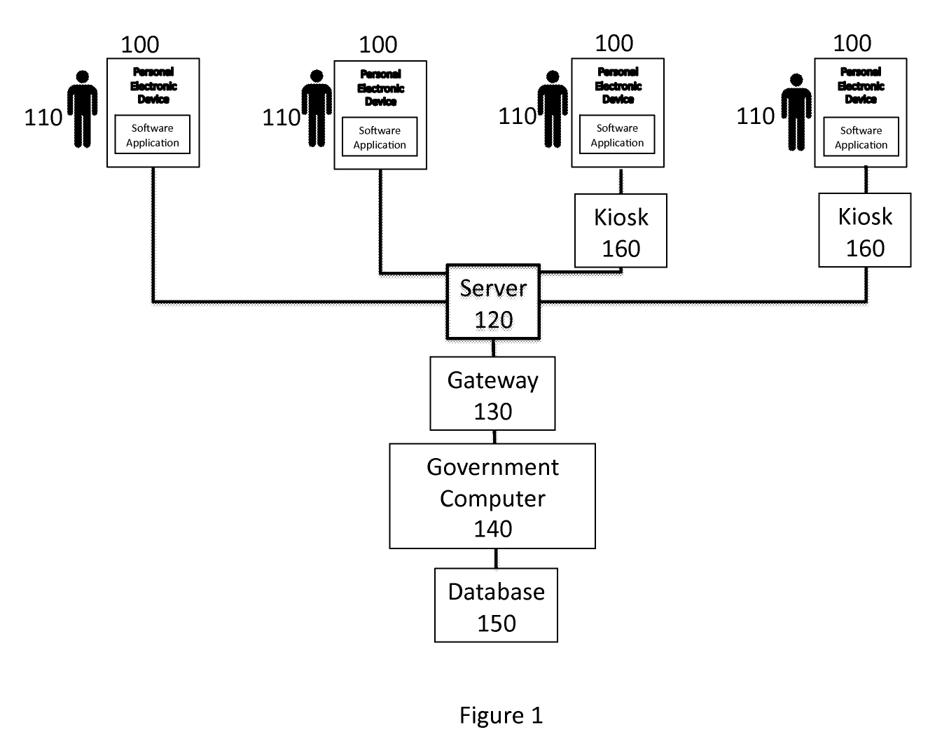

As seen in FIG. 1, personal electronic devices with the App installed 100 are in communication with government computer 140 through secure gateway 130 over a secure communications network that includes the wireless network and server network 120. Government computer 140 may be a conventional server or servers, and has access to a customs database 150 containing information about travelers and travel document holders. Kiosks 160 may be in a network, wherein each kiosk 160 is in communication with server 120. Server 120 is then in communication with interface 130, which acts as a gateway between server 120 and government computer 140.

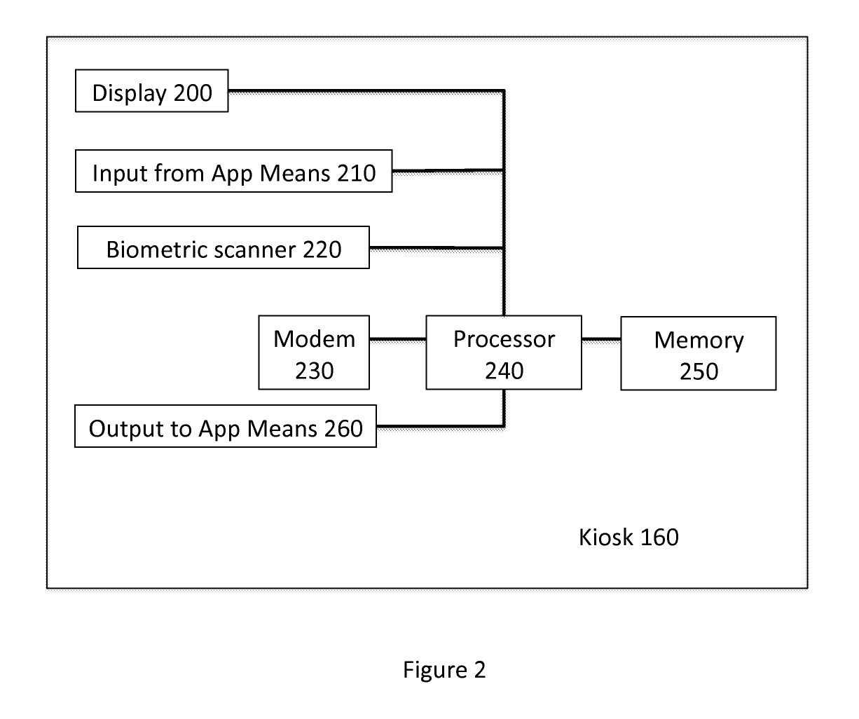

As seen in FIG. 2, kiosk 160 include a display 200 and input means 210 which could take the form of an optical reader or a wireless reader to receive information from the App installed on personal electronic device 100. Biometric scanner 220 is an off-the-shelf scanner that meets the appropriate government specifications and may include a device for retinal or fingerprint scanning. Kiosk 160 also includes a modem 230 for communications with government computer 140. Kiosks 160 also includes conventional computer components, such as processor 240 and memory 250. Kiosk 160 will include output means 260 which could take form of an optical display or wireless transmitter to communicate to the App installed on personal electronic device 100.

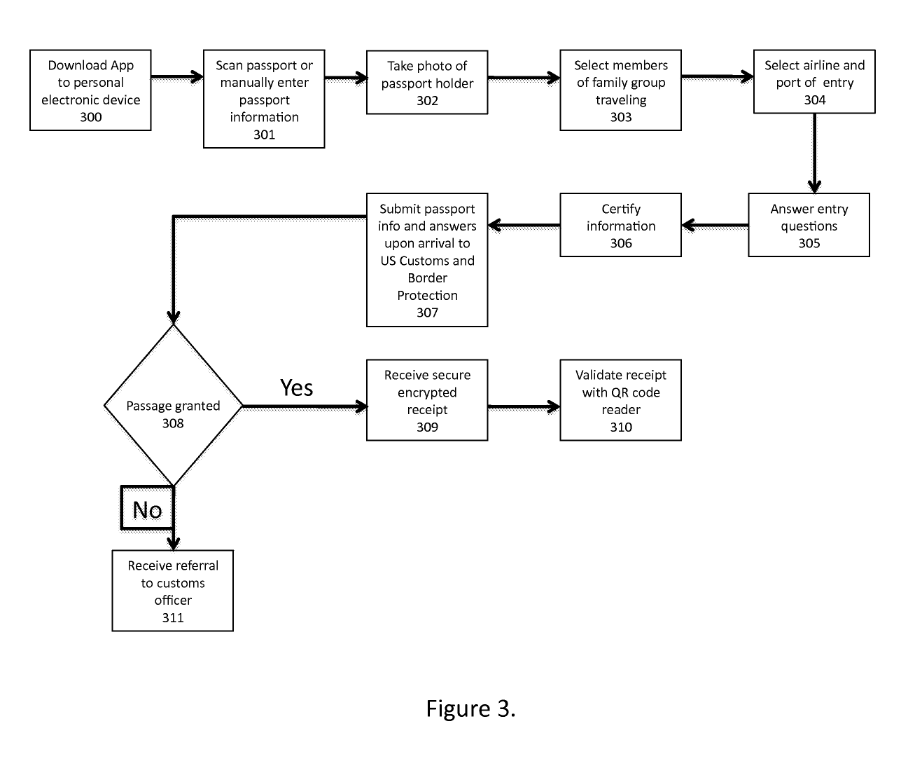

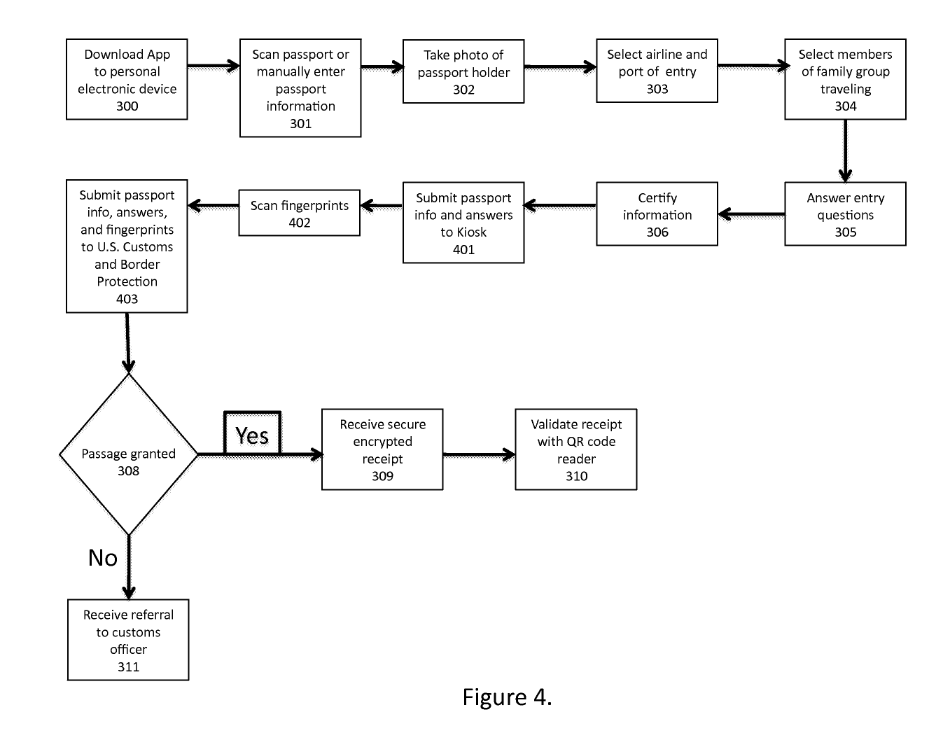

As seen in FIGS. 3 and 4, travelers may download the App to their personal electric device 100 at any time (step 300). They may either scan their passport using the optical character recognition function or enter their passport information manually (step 301) and save the information on the device 100. After the passport information has been entered, travelers will be prompted to take a photograph of the passport holder (step 302). For each trip into a jurisdiction, the traveler will select the members of family group traveling together (step 303). The travel will select the carrier and vessel number that transported the traveler into the jurisdiction (step 304). In this embodiment, the traveler will select an airline and the flight number. In step 305 the traveler must answer a series of questions related to their travel and then certify the information is complete and accurate (step 306).

As seen in FIG. 3, upon arrival into the jurisdiction, travelers that are not required to submit a biometric will submit their passport information and answers to the custom authority via the App (step 307). In step 308, the custom authority will determine whether the passenger has been granted passage to enter the jurisdiction. If passage is granted, the traveler will receive a secure encrypted receipt via the App (step 309). The passenger will proceed to QR reader to validate the receipt (step 310). Upon validation, a customs officer may allow the traveler to enter into the jurisdiction. If passage is not granted in step 308, the traveler will be referred to a customs officer to proceed with the typical border crossing process (step 311).

As seen in FIG. 4, upon arrival into the jurisdiction, travelers that are required to submit a biometric will use kiosk 160. In step 401, the traveler will submit passport information and answers stored in the App to kiosk 160. Once the information has been accessed by kiosk 160, traveler 110 will submit to a biometric scan via kiosk 160 (step 402). In step 403, kiosk 160 will submit traveler passport information, biometrics and answers to the government computer. If passage is granted, the traveler will receive a secure encrypted receipt via the App (step 309). The can happen through the wireless network or through an output means from kiosk 160. The passenger will proceed to a QR code reader to validate the receipt (step 310). Upon validation, a customs officer may allow the traveler to enter into the jurisdiction. If passage is not granted in step 308, the traveler will be referred to a customs officer to proceed with the typical border crossing process (step 311).

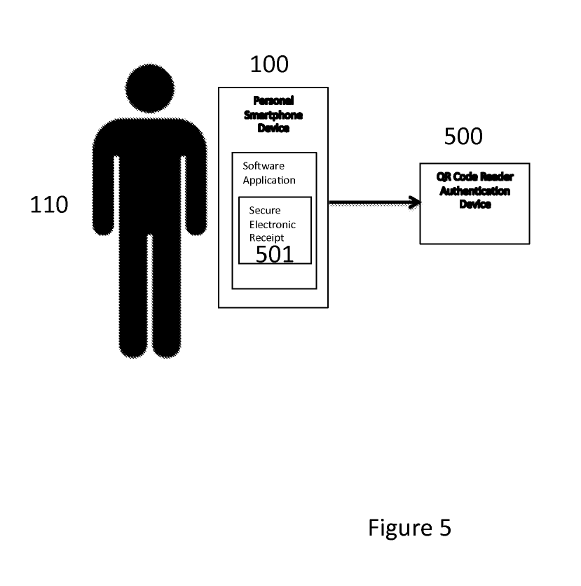

As seen in FIG. 5, traveler 110 will present the secure encrypted receipt 501 displayed on personal electronic device 100 to the QR code reader 500 to validate that the receipt 501 is authentic, has not been tampered with and is being presented within the valid time window.

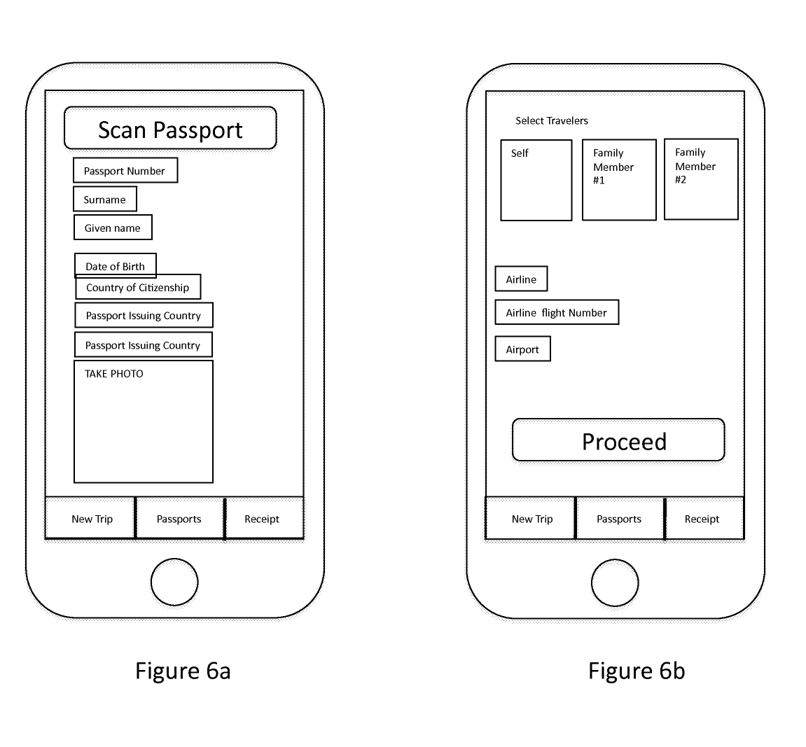

As seen in FIGS. 6a-6c, the App will have a number of user screens to allow the traveler to provide passport information, take a picture of passport holders, select travelers, airline and port of entry and answer entry questions.

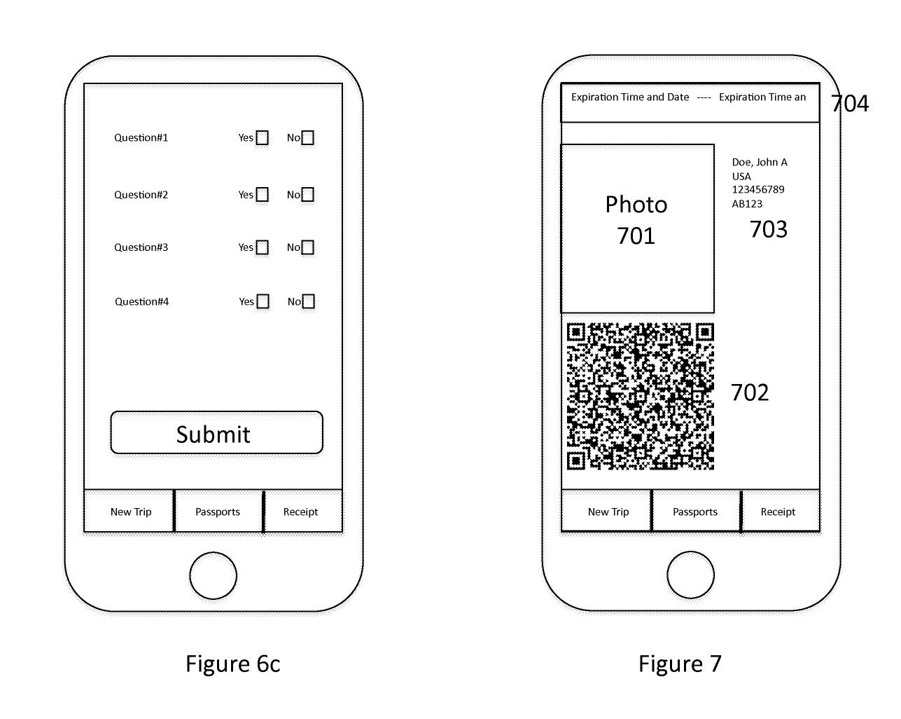

As seen in FIG. 7, once customs grants entry to the traveler, the traveler will receive a secure, encrypted receipt via the App to be presented to a QR code reader. The receipt will include: a photograph of the passport holder 701, a encrypted QR code 702, traveler information 703 including, name, passport number, and airline and flight number, a scrolling date and time stamp 704 that indicate when the receipt will expire, and (5) and interactive element that a custom officer can request further validate the authenticity of the receipt (not pictured).

What is claimed is:

1. A system comprising of:
a personal electronic device software application for electronically reading and receiving official passport data for a traveler and members of the traveler's family group, for storing images used to identify each passport holder, for posing a series of questions to the traveler related to the traveler's trip, for transmitting encrypted passport information and answers to travel questions to a server, for receiving encrypted codes from the customs authorities regarding the traveler's authorization to enter the jurisdiction, for displaying an electronic receipt with a photograph of the traveler, traveler information, an encrypted QR code, a scrolling date and time stamp, and interactive elements;
a system to transmit encrypted passport and travel information to customs authorities, which includes wireless communication from a personal electronic device, to determine whether the travelers is authorized to enter the jurisdiction;
a system for receiving authorization to enter into a jurisdiction;
a system for transmitting encrypted codes from the customs authorities regarding the traveler's authorization to enter the jurisdiction to a personal electronic device application; and
a system for authenticating the receipt, which includes the use of QR code readers.

2. The system of claim 1 further comprising: of:
a personal electronic device-based software application program executable on a personal electronic device;
computer executable instructions executable by the at least one computer processor and configured to perform any one or more of the following:
(i) receive encrypted passport and travel information from the personal electronic device-based software application;
(ii) transmit encrypted passport and travel information to appropriate customs authority;
(iii) receive authorization codes from a customs authority; and
(iv) transmit authorization codes to the personal electronic device-based software application for use in an electronic receipt.

3. The system of claim 1, wherein the personal electronic device-based software application is an application in native personal electronic device-based software application operating language such as iOS, Android, or Windows Mobile or HTML5.

4. The system of claim 1, wherein the personal electronic device-based software application includes memory means.

5. The system of claim 4, wherein the memory means may include any one or more of the following stored thereon: at least one picture, identification information, travel information, authorization, or other data structures.

6. The system of claim 5, wherein data structures include but are not limited to: passport number, travel identification number, security parameters, visa restrictions, and identification information.

7. The system of claim 5, wherein identification information includes but is not limited to: name, date of birth, sex, issue date, height, and passport number.

8. The system of claim 1, wherein the personal electronic device-based software application is configured for communicating with the computer wirelessly.

9. A method comprising of:
a personal electronic device software application for electronically reading and receiving official passport data for a traveler and members of the traveler's family group, for storing images used to identify each passport holder, for posing a series of questions to the traveler related to the traveler's trip, for transmitting encrypted passport information and answers to travel questions to a server, for receiving encrypted codes from the customs authorities regarding the traveler's authorization to enter the jurisdiction, for displaying an electronic receipt with a photograph of the traveler, traveler information, an encrypted QR code, a scrolling date and time stamp, and interactive elements;
a method to transmit encrypted passport and travel information to customs authorities, which includes wireless communication from a personal electronic device, to determine whether the travelers is authorized to enter the jurisdiction;
a method for receiving authorization to enter into a jurisdiction;
a method for transmitting encrypted codes from the customs authorities regarding the traveler's authorization to enter the jurisdiction to a personal electronic device application; and
a method for authenticating the receipt, which includes the use of QR code readers.

10. The method of claim 9 further comprising: of:
a personal electronic device-based software application program executable on a personal electronic device;
computer executable instructions executable by the at least one computer processor and configured to perform any one or more of the following:
(i) receive encrypted passport and travel information from the personal electronic device-based software application;
(ii) transmit encrypted passport and travel information to appropriate customs authorities;
(iii) receive authorization codes from a customs authority; and
(iv) transmit authorization to the personal electronic device-based software application for use in an electronic receipt.

11. The method of claim 9, wherein the personal electronic device-based software application is an application in native personal electronic device-based software application operating language such as iOS, Android, or Windows Mobile or HTML5.

12. The method of claim 9, wherein the personal electronic device-based software application includes memory means.

13. The method of claim 12, wherein the memory means may include any one or more of the following stored thereon: at least one picture, identification information, travel information, authorization, or other data structures.

14. The method of claim 13, wherein data structures include but are not limited to: passport number, travel identification number, security parameters, visa restrictions, and identification information.

15. The method of claim 13, wherein identification information includes but is not limited to: name, date of birth, sex, issue date, height, and passport number.

16. The method of claim 9, wherein the personal electronic device-based software application is configured for communicating with the computer wirelessly.

17. A system comprising of:
a personal electronic device software application for electronically reading and receiving official passport data for a traveler and members of the traveler's family group, for storing images used to identify each passport holder, for posing a series of questions to the traveler related to the traveler's trip, for transmitting encrypted passport information and answers to travel questions to a kiosk, for receiving encrypted codes from the customs authorities regarding the traveler's authorization to enter the jurisdiction, and for displaying an electronic receipt with a photograph of the traveler, traveler information, an encrypted QR code, a scrolling date and time stamp, and interactive elements;
a kiosk for receiving transmitting encrypted passport information and answers to travel questions, for scanning traveler's biometrics from a personal electronic device software application, for transmitting encrypted passport information, answers to travel questions, and traveler's biometrics to a server, and for receiving encrypted codes from the customs authorities regarding the traveler's authorization to enter the jurisdiction;
a system to transmit encrypted passport and travel information to customs authorities, which includes wireless communication from a personal electronic device, to determine whether the travelers is authorized to enter the jurisdiction;
a system for receiving authorization to enter into a jurisdiction;
a system for transmitting encrypted codes from the customs authorities regarding the traveler's authorization to enter the jurisdiction to a personal electronic device application; and
a system for authenticating the receipt, which includes the use of QR code readers.

18. The system of claim 17 further comprising: of:
a personal electronic device-based software application program executable on a personal electronic device;
a kiosk-based software application executable on a kiosk;
computer executable instructions executable by the at least one computer processor and configured to perform any one or more of the following:
(i) receive encrypted passport and travel information from the personal electronic device-based software application;
(ii) transmit encrypted passport and travel information to a kiosk appropriate customs authorities;
(iii) receive authorization codes from a customs authority; and
(iv) transmit authorization to the personal electronic device-based software application for use in an electronic receipt.

19. The system of claim 17, wherein the personal electronic device-based software application is an application in native personal electronic device-based software application operating language such as iOS, Android, or Windows Mobile or HTML5.

20. The system of claim 17, wherein the personal electronic device-based software application includes memory means.

21. The system of claim 21, wherein the memory means may include any one or more of the following stored thereon: at least one picture, identification information, travel information, authorization, or other data structures.

22. The system of claim 21, wherein data structures include but are not limited to: passport number, travel identification number, security parameters, visa restrictions, and identification information.

23. The system of claim 21, wherein identification information includes but is not limited to: name, date of birth, sex, issue date, height, and passport number.

24. The system of claim 17, wherein the personal electronic device-based software application is configured for communicating with the kiosk wirelessly.

25. The system of claim 17, wherein the kiosk is configured for communicating with the personal electronic device-based software application wirelessly.

26. A method comprising of:
a personal electronic device software application for electronically reading and receiving official passport data for a traveler and members of the traveler's family group, for storing images used to identify each passport holder, for posing a series of questions to the traveler related to the traveler's trip, for transmitting encrypted passport information and answers to travel questions to a kiosk, for receiving encrypted codes from the customs authorities regarding the traveler's authorization to enter the jurisdiction, and for displaying an electronic receipt with a photograph of the traveler, traveler information, an encrypted QR code, a scrolling date and time stamp, and interactive elements;
a kiosk for receiving transmitting encrypted passport information and answers to travel questions, for scanning traveler's biometrics from a personal electronic device software application, for transmitting encrypted passport information, answers to travel questions, and traveler's biometrics to a server, and for receiving encrypted codes from the customs authorities regarding the traveler's authorization to enter the jurisdiction;
a method to transmit encrypted passport and travel information to customs authorities, which includes wireless communication from a personal electronic device, to determine whether the travelers is authorized to enter the jurisdiction;
a method for receiving authorization to enter into a jurisdiction;
a method for transmitting encrypted codes from the customs authorities regarding the traveler's authorization to enter the jurisdiction to a personal electronic device application; and
a method for authenticating the receipt, which includes the use of QR code readers.

27. The method of claim 26 further comprising: of:
a personal electronic device-based software application program executable on a personal electronic device;
a kiosk-based software application executable on a kiosk;
computer executable instructions executable by the at least one computer processor and configured to perform any one or more of the following:
(i) receive encrypted passport and travel information from the personal electronic device-based software application;
(ii) transmit encrypted passport and travel information to a kiosk appropriate customs authorities;
(iii) receive authorization codes from a customs authority; and
(iv) transmit authorization to the personal electronic device-based software application for use in an electronic receipt.

28. The method of claim 26, wherein the personal electronic device-based software application is an application in native personal electronic device-based software application operating language such as iOS, Android, or Windows Mobile or HTML5.

29. The method of claim 26, wherein the personal electronic device-based software application includes memory means.

30. The method of claim 29, wherein the memory means may include any one or more of the following stored thereon: at least one picture, identification information, travel information, authorization, or other data structures.

31. The method of claim 29, wherein data structures include but are not limited to:
passport number, travel identification number, security parameters, visa restrictions, and identification information.

32. The method of claim 31, wherein identification information includes but is not limited to: name, date of birth, sex, issue date, height, and passport number.

33. The method of claim 26, wherein the personal electronic device-based software application is configured for communicating with the kiosk wirelessly.

34. The method of claim 26, wherein the kiosk is configured for communicating with the personal electronic device-based software application wirelessly.
